(19) United States
(12) Patent Application Publication
(10) Pub. No.: US 2025/0160577 A1
(43) Pub. Date: May 22, 2025

(54) COMBINATION ADJUSTABLE SHOWER SEAT AND SHELVING UNIT

(71) Applicant: Michael Chad Watts, Centennial, CO (US)

(72) Inventor: Michael Chad Watts, Centennial, CO (US)

(21) Appl. No.: 18/515,086

(22) Filed: Nov. 20, 2023

(51) Int. Cl. A47K 3/28

(52) U.S. Cl. CPC A47K 3/282; A47K 3/281

(57) ABSTRACT

An adjustable shower seat and shelving unit including an adjustable pole, a top shelf disposed near a top portion of the adjustable pole, and a bottom shelf disposed near a bottom portion of the adjustable pole.

### BACKGROUND

### 1. Field

The present general inventive concept relates generally to a seat and a shelf, and particularly, to an adjustable seat and shelf usable in a shower and/or bathtub.

### 2. Description of the Related Art

In the marketplace, there are many different types of shelving units that can be installed in shower stalls and/or bathtubs, in order to allow consumers to store their toiletries for easy access while bathing.

Also, there are various types of seats that are designed to fit in bathtubs and/or showers, to allow consumers to bathe more comfortably while in a seated position without having to sit on the floor of the bathtub or shower.

However, since not all people like to sit while they bathe, there is a need for a more versatile device that allows for maximized use of space when bathing, as well as more potential storage space.

Also, since people vary in height, there is also a need for an adjustable shower seat for those people who prefer to sit while bathing without having to sit on the floor of the bathtub or shower.

### SUMMARY

The present general inventive concept provides a wildfire elimination system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an adjustable shower seat and shelving unit including an adjustable pole, a top shelf disposed near a top portion of the adjustable pole, and a bottom shelf disposed near a bottom portion of the adjustable pole.

The adjustable pole may include a bottom pole section to contact a floor, and a top pole section to slide within the bottom pole section to allow a length of the adjustable pole to be adjusted.

The bottom shelf may include a plurality of telescoping legs, and a plurality of hinges connected to first ends of the plurality of telescoping legs to allow the plurality of telescoping legs to swing from a first position to a second position.

The first position of the plurality of telescoping legs may be when the plurality of telescoping legs are disposed at a substantially orthogonal angle with respect to the bottom shelf, and the second position of the plurality of telescoping legs may be when the plurality of telescoping legs are disposed parallel with respect to the bottom shelf.

At least one of the top shelf and the bottom shelf may be movable up and down a length of the adjustable pole.

The bottom shelf may have a size that is large enough for a user to sit upon.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates an elevational front angled view of an adjustable shower seat and shelving unit in a first position, according to an exemplary embodiment of the present general inventive concept; and

FIG. 1B illustrates an elevational front angled view of the adjustable shower seat and shelving unit in a second position, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Adjustable Shower Seat and Shelving Unit 100

Adjustable Pole 110

First Pole Section 111

Second Pole Section 112

Pole Base 113

Top Shelf 120

Top Shelf Slits 121

Bottom Shelf 130

Bottom Shelf Slits 131

Telescoping Legs 132

Leg Hinges 133

Leg Bases 134

Suction Cups 140

Hooks 150

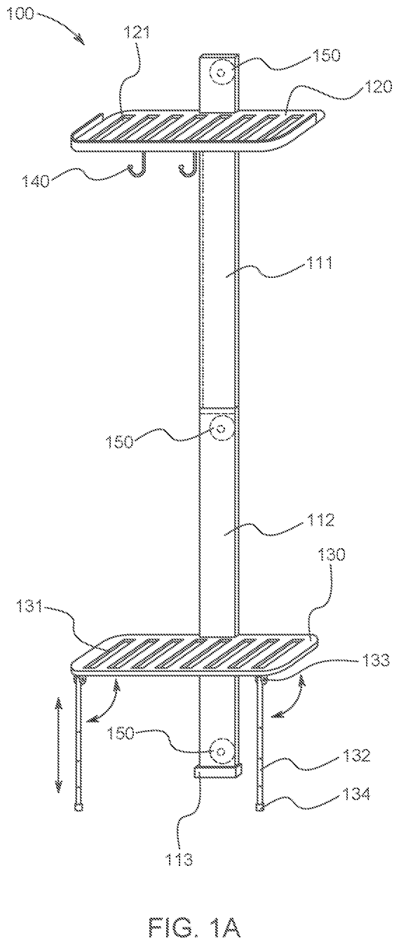

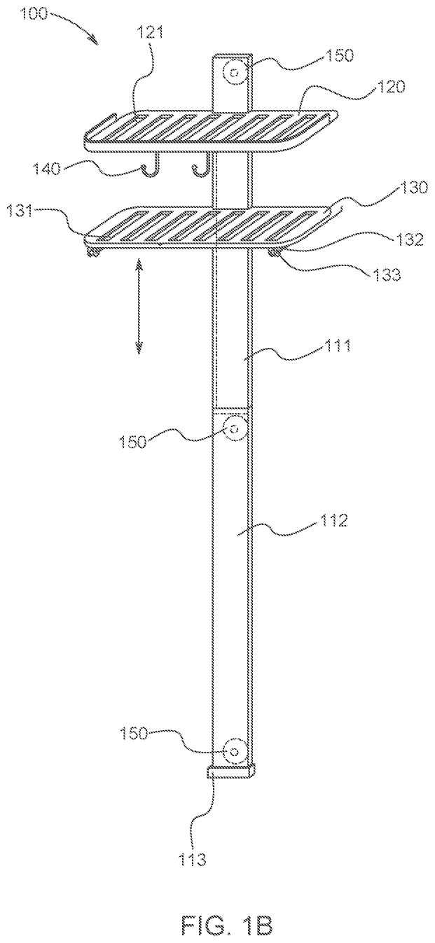

FIG. 1A illustrates an elevational front angled view of an adjustable shower seat and shelving unit 100 in a first position, according to an exemplary embodiment of the present general inventive concept.

FIG. 1B illustrates an elevational front angled view of the adjustable shower seat and shelving unit 100 in a second position, according to an exemplary embodiment of the present general inventive concept.

The adjustable shower seat and shelving unit 100, and all associated components connected thereto, may be constructed from at least one of metal, plastic, wood, glass, and rubber, etc., but is not limited thereto.

The adjustable shower seat and shelving unit 100 may include an adjustable pole 110, a top shelf 120, a bottom shelf 130, a plurality of suction cups 140, and a plurality of hooks 150, but is not limited thereto.

The adjustable pole 110 may include a first pole section 111 and a second pole section 112, but is not limited thereto.

Referring to FIG. 1A, the first pole section 111 is illustrated as a top pole section and the second pole section 112 is illustrated as a bottom pole section 112, and the first pole section 111 is slidably adjustable with respect to the bottom pole section 112 such that the top pole section 111 slides within the bottom pole section 112, but the adjustable pole 110 can be reversed so that the bottom pole section 112 may slide within the top pole section 111. Accordingly, the adjustable pole 110 can vary in length based on a user's preference, but sliding the first pole section 111 up and down with respect to the bottom pole section 112.

The adjustable pole 110 may include a pole base 113 disposed at a base portion of the adjustable pole 110, in order to allow the adjustable pole 110 to remain stationary and not damage a floor of a shower and/or bathtub. As such, the pole base 113 may be constructed from rubber, plastic, or any other type of material that is able to avoid scratching a surface.

The top shelf 120 may include a plurality of top shelf slits 121 to allow water to drain therethrough.

Referring to FIGS. 1A and 1B, the top shelf 120 may remain stationary with respect to the top pole section 111, but is not limited thereto, and may slide up and down the adjustable pole 110 based on the user's preference.

The bottom shelf 130 may include a plurality of bottom shelf slits 131 to allow water to drain therethrough.

Referring to FIGS. 1A and 1B, the bottom shelf 130 may slide up and down the adjustable pole 110 based on the user's preference.

Referring to FIGS. 1A and 1B, the bottom shelf 130 may include a plurality of telescoping legs 132, a plurality of leg hinges 133, and a plurality of leg bases 134.

The plurality of telescoping legs 132 may be attached by the plurality of leg hinges 133 to a bottom portion of the bottom shelf 130, such that the plurality of telescoping legs 132 may use the plurality of leg hinges 133 as fulcrum points to swing from an open position as illustrated in FIG. 1A to a closed position (i.e., pressed against the bottom portion of the bottom shelf 130) as illustrated in FIG. 1B.

The plurality of telescoping legs 132 may be divided into a plurality of sections to allow the plurality of telescoping legs 132 to become longer or shorter by pulling and/or turning each of the sections, for example, based on the user's preference. As such, the plurality of telescoping legs 132 may extend to be longer, or may be compacted to be shorter, based on a height of the user.

Alternatively, the plurality of telescoping legs 132 may be constructed as single leg pieces without sections to prevent the telescoping legs 132 from being able to change in length. In other words, exemplary embodiments of the present general inventive concept do not require the telescoping legs 132 to perform a telescoping function.

The plurality of leg bases 134 may be disposed on bottom portions of the plurality of telescoping legs 132 in order to allow the plurality of telescoping legs 132 to remain stationary and not damage a floor of a shower and/or bathtub. As such, the plurality of leg bases 134 may be constructed from rubber, plastic, or any other type of material that is able to avoid scratching a surface.

The bottom shelf 130 may be larger than the top shelf 120, so that the bottom shelf 130 may function as a seat for the user to sit upon while bathing.

Referring to FIGS. 1A and 1B, a plurality of suction cups 140 may be attached to back portions of the top pole section 111 and the bottom pole section 112, in order to allow the adjustable pole 110 to be attached to a wall. The wall may be in a shower and/or a bathtub, but is not limited thereto.

Referring to FIGS. 1A and 1B, a plurality of hooks 150 may be attached to the top shelf 120. Alternatively, the plurality of hooks 150 may be attached to the bottom shelf 130.

The plurality of hooks 150 may be used to allow the user to hang objects therefrom, such as towels, washcloths, soap, etc., but are not limited thereto.

The present general inventive concept include an adjustable shower seat and shelving unit 100 including an adjustable pole 110, a top shelf 120 disposed near a top portion of the adjustable pole 110, and a bottom shelf 130 disposed near a bottom portion of the adjustable pole 110.

The adjustable pole 110 may include a bottom pole section 112 to contact a floor, and a top pole section 111 to slide within the bottom pole section 112 to allow a length of the adjustable pole 110 to be adjusted.

The bottom shelf may include a plurality of telescoping legs 132, and a plurality of hinges 133 connected to first ends of the plurality of telescoping legs 132 to allow the plurality of telescoping legs 132 to swing from a first position to a second position.

The first position of the plurality of telescoping legs 132 may be when the plurality of telescoping legs 132 are disposed at a substantially orthogonal angle with respect to the bottom shelf 130, and the second position of the plurality of telescoping legs 132 may be when the plurality of telescoping legs 132 are disposed parallel with respect to the bottom shelf 130.

At least one of the top shelf 120 and the bottom shelf 130 may be movable up and down a length of the adjustable pole 110.

The bottom shelf 130 may have a size that is large enough for a user to sit upon.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An adjustable shower seat and shelving unit, comprising:
an adjustable pole;
a top shelf disposed near a top portion of the adjustable pole; and
a bottom shelf disposed near a bottom portion of the adjustable pole.

2. The adjustable shower seat and shelving unit of claim 1, wherein the adjustable pole comprises:
a bottom pole section to contact a floor; and
a top pole section to slide within the bottom pole section to allow a length of the adjustable pole to be adjusted.

3. The adjustable shower seat and shelving unit of claim 1, wherein the bottom shelf comprises:
a plurality of telescoping legs; and
a plurality of hinges connected to first ends of the plurality of telescoping legs to allow the plurality of telescoping legs to swing from a first position to a second position.

4. The adjustable shower seat and shelving unit of claim 3, wherein the first position of the plurality of telescoping legs is when the plurality of telescoping legs are disposed at a substantially orthogonal angle with respect to the bottom shelf, and the second position of the plurality of telescoping legs is when the plurality of telescoping legs are disposed parallel with respect to the bottom shelf.

5. The adjustable shower seat and shelving unit of claim 1, wherein at least one of the top shelf and the bottom shelf is movable up and down a length of the adjustable pole.

6. The adjustable shower seat and shelving unit of claim 1, wherein the bottom shelf has a size that is large enough for a user to sit upon.
